(19) United States
(12) Patent Application Publication
(10) Pub. No.: US 2017/0294280 A1
(43) Pub. Date: Oct. 12, 2017

(54) ARRANGEMENT AND A METHOD FOR SWITCHING AN OPEN CONTACT GAP BY A SWITCHING DEVICE

(71) Applicant: SIEMENS AKTIENGESELLSCHAFT, München (DE)

(72) Inventors: Benjamin Sewiolo, Obermichelbach (DE); Andreas Ziroff, München (DE)

(21) Appl. No.: 15/511,922

(22) PCT Filed: Sep. 7, 2015
(86) PCT No.: PCT/EP2015/070324

§ 371 Date: Mar. 16, 2017

(30) Foreign Application Priority Data
Sep. 22, 2014 (DE) 102014219088.6

(51) Int. Cl. H01H 33/666; H01H 33/59; H01H 33/66; H01H 33/664; H01H 33/42; H01H 33/662

(52) U.S. Cl. CPC H01H 33/666; H01H 33/423; H01H 33/662; H01H 33/6606; H01H 33/664; H01H 33/59

(57) ABSTRACT

The disclosure relates to an arrangement and a method for switching an open contact gap by a switching device, wherein a galvanically isolated energy transmission of high-frequency energy provides an actuator energy for at least one switching device, in particular a vacuum interrupter. For the purpose of energy transmission, the switching device is connected to the high-frequency source via a dielectric resonator, the switching device being designed such as to be configured for converting the transmitted energy into actuator energy.

The present patent document is a §371 nationalization of PCT Application Serial Number PCT/EP2015/070324, filed Sep. 7, 2015, designating the United States, which is hereby incorporated by reference, and this patent document also claims the benefit of DE 10 2014 219 088.6, filed Sep. 22, 2014, which is also hereby incorporated by reference.

### TECHNICAL FIELD

The disclosure relates to an arrangement and a method for switching an open contact gap by a switching device.

### BACKGROUND

The use of switches in electrical engineering is known. Switches in electronics are operated in a current and voltage range that generally does not impose any particular load or requirements on the switch.

In contrast, switches in medium-voltage technology are used with different tasks, (e.g., as circuit breakers, load switches, isolating switches, load-break switches, grounding switches, or protective switches). On account of their generally more complex structure, they are also referred to as switching devices in a generalized manner.

In this case, given loads are no-load switching, switching of operating currents, and switching of short-circuit currents.

Requirements involve, for example, the switching device being intended to provide as little resistance as possible to the flow of operating and short-circuit currents in the closed state. In contrast, the open contact gap safely withstands the voltages occurring at it in the open state.

Additionally, all live parts are sufficiently insulated with respect to ground and from phase to phase when the switching device is open or closed.

Furthermore, the switching device is intended to be able to close the circuit when a voltage is applied. However, in the case of isolators, this condition is required only for the de-energized state, apart from small charging currents. In addition, the switching device is intended to be able to open the circuit when current flows (e.g., this requirement is not made for isolators).

The switching device is also intended to cause switching overvoltages that are as low as possible.

Known switching devices that meet these requirements use vacuum interrupters, as depicted in FIG. 1. These are fastened to a frame with the aid of insulators, for example in the case of a circuit breaker as depicted in FIG. 2, and are mechanically switched with the aid of a lever.

On account of the high mechanical load, this mechanical switching operation allows 10,000-120,000 switching cycles depending on the model according to the data sheet, the drives being oiled after 10,000 switching cycles, and the vacuum interrupters having to be replaced after 30,000 switching cycles.

In this case, the entire drive mechanism with trip elements, auxiliary switches, display, and actuation devices is accommodated in a drive box.

The closing spring is tensioned electrically or manually. It latches after the tensioning operation has ended and is used as a mechanical energy store. The force from the drive to the switch poles is transmitted via switch rods.

For switching-on, the closing spring is unlatched mechanically in situ or is unlatched electrically by remote actuation. During the switching-on operation, the closing spring tensions the opening or contact pressure springs. The closing spring, which is now unloaded, is automatically tensioned again by the drive motor or manually, in which case the latter has the disadvantage of the presence of a person who is additionally also exposed to hazards under certain circumstances.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The object of the disclosure is to specify a method and an arrangement that overcome the disadvantages of the above-mentioned solutions.

This object is achieved by an arrangement for switching open contact gaps by switching devices and by a method for switching open contact gaps by switching devices.

In the arrangement for switching open contact gaps by switching devices, DC-isolated energy transmission of radio-frequency energy provides actuator energy for at least one switching device, (e.g., a vacuum interrupter), and the switching device is connected to the radio-frequency source via a dielectric resonator for the purpose of energy transmission, the switching device being configured to convert the transmitted energy into actuator energy.

The practice of transmitting and providing the radio-frequency energy dispenses with manual intervention for switching. Furthermore, this solution enables and supports the fact that the use of mechanical components and also mechanical operations is minimized, with the result that wear is considerably reduced. In addition, radio-frequency energy transmission is associated with the possibility of transmitting information on the same path in a bidirectional manner.

The use of a dielectric resonator for energy transmission, to which the switching device is connected for this purpose, enables operation using a low frequency in the MHz range, which in turn results in higher energy efficiency. In this case, the switching device is configured to convert the transmitted energy into actuator energy. In addition to the transmission of the energy (also called transmission of the power in the technical jargon) required for switching, further advantages lie in the insulation and stabilization of the arrangement if a dielectric waveguide is involved. Furthermore, arising heat may be dissipated via the resonator.

In this case, the dielectric resonator may be developed in the form of a high-quality dielectric resonator.

If the dielectric resonator is in the form of a disk and is arranged and formed on the side of the switching lever of the switching device, (e.g., bolts of the vacuum tube), in such a manner that it stabilizes the movement of the switching lever in a guiding manner, it may stabilize the switching device overall. In this case, the arrangement is more compact because the lever is guided in or through a formation of the disk.

The arrangement may be advantageously developed in such a manner that the switching lever is formed from metal or a dielectric material. This allows further optimizations if it is dielectric. The switching lever may also be in the form of a simple metal and may be used as part of a magnetic switch and may therefore further improve the compactness, for example.

If the arrangement is developed in such a manner that the switching device includes at least one rectifier arrangement to convert the energy, the radio-frequency energy is transformed into electrical variables suitable for energy storage or for electrically operated switches, as are provided in the development in which electrically operated switches, (e.g., relay switches), are connected downstream of the energy transmission as actuators.

If the switching device includes at least two parallel rectifier arrangements, higher radio-frequency (RF) powers may be transmitted.

In one development, the resonator includes a solid dielectric material such as aluminum oxide or another dielectric material with a high relative permittivity or dielectric constant (Er), (for example, titanium dioxide, zirconium, or silicon carbide). With its higher thermal conductivity, for example, silicon carbide contributes to better heat dissipation of the arrangement.

Alternatively, or additionally, the arrangement may be developed in such a manner that the waveguide is formed from a flexible material filled with dielectric liquids. This makes it possible to form geometric structures, for example, which may in turn contribute to optimizing the arrangement.

If at least parts of the elements of the switching arrangement are provided with sensors, operating information relating to parts of the interrupter, (e.g., the mechanical actuator), may be additionally transmitted via the waveguide in the opposite direction to the energy transmission or in a bidirectional manner. This may contribute to the ease of servicing of the interrupter and may indicate a possible fault in good time and may possibly prevent failure.

In the method for switching open contact gaps by switching devices, DC-isolated energy transmission of radio-frequency energy provides actuator energy for at least one switching device, (e.g., a vacuum interrupter), and the switching device is connected to the radio-frequency source via a dielectric resonator for the purpose of energy transmission, the switching device being configured in such a manner that it is configured to convert the transmitted energy into actuator energy. Through its features, the method lays the foundation for using the advantages by the arrangement and its developments.

### BRIEF DESCRIPTION OF THE DRAWINGS

The disclosure and further advantages are explained in more detail below proceeding from the arrangements according to the prior art shown in FIGS. 1 to 2 and on the basis of the exemplary embodiments illustrated in FIGS. 3 and 4. In the drawings:

FIG. 1 depicts an example of a switching device formed by vacuum interrupters.

FIG. 2 depicts an example of a use of the vacuum tube switching device as a circuit breaker.

FIG. 3 depicts a first exemplary embodiment in a side view with a dielectric switching bolt.

FIG. 4 depicts a second exemplary embodiment in a side view with metal switching bolts.

### DETAILED DESCRIPTION

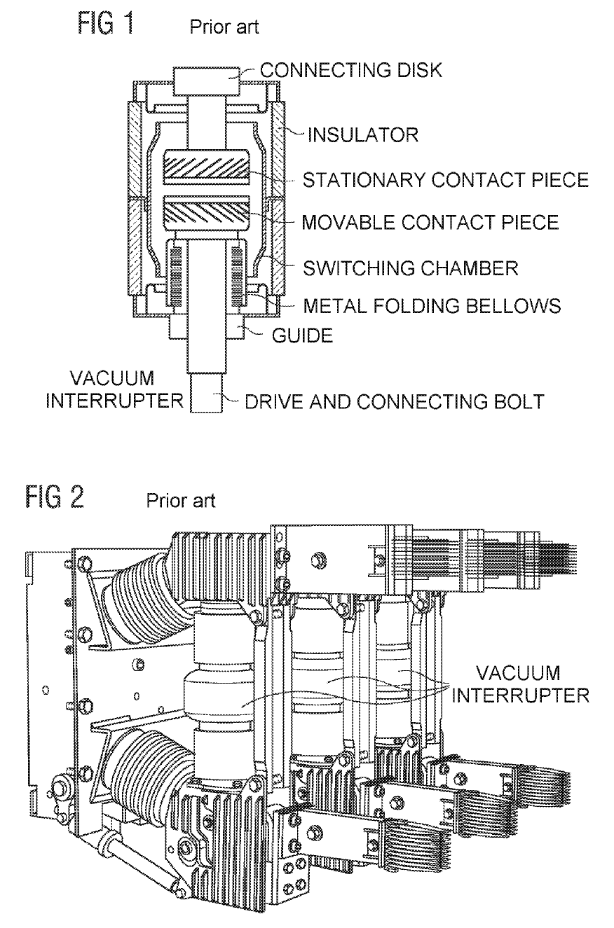

FIG. 1 illustrates a switching device formed by a vacuum interrupter. It is possible to see the typical structure starting with a drive and connecting bolt, a guide for the latter, a movable contact piece that is mounted, in a manner surrounded by folding bellows, in a switching chamber encased by an insulator and in which a stationary contact piece is also mounted opposite the movable contact piece and is terminated in a connection disk.

FIG. 2 illustrates a plurality of the switching devices illustrated in the previous figure in a manner installed in a circuit breaker arrangement. In this case, it is possible to also see, in the left-hand part of the illustration, the lever moving the drive and connecting bolt during a switching operation and brings together or separates the two contact pieces and therefore closes or opens the circuit.

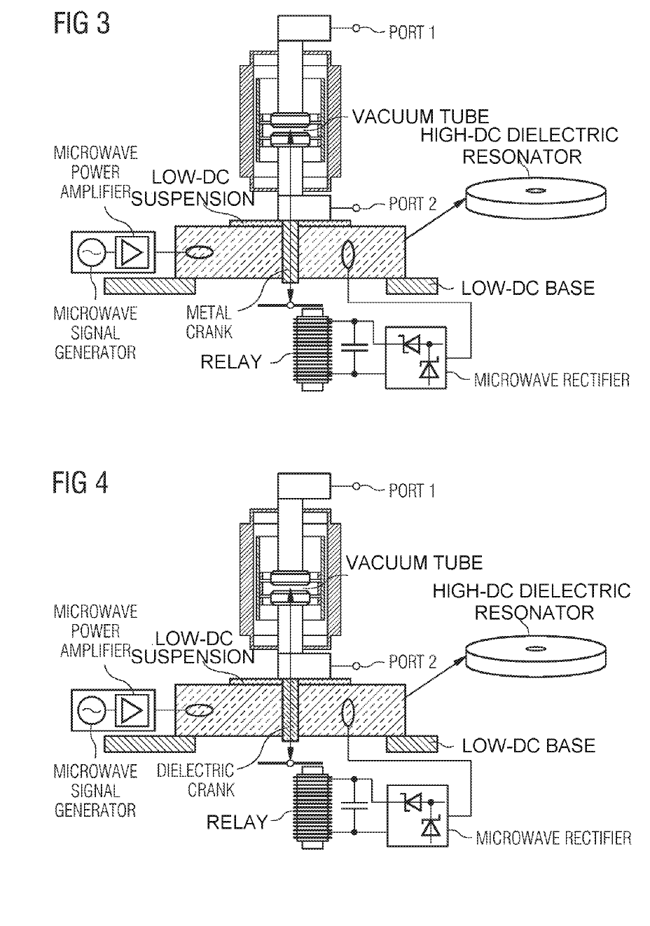

One of the elements of the circuit breaker, modified according to one exemplary embodiment, is depicted in a side illustration in FIG. 3. It is possible to see how the vacuum interrupter VACUUM TUBE in the circuit breaker arrangement is fixed between an upper carrier PORT 1 and a lower interrupter carrier PORT 2.

Proceeding from the arrangement shown, the exemplary embodiment now stands out from the prior art, in particular, by virtue of the fact that the lower insulator INSULATOR is dispensed with and the insulation is effected instead by a dielectric resonator HIGH-DC DIELECTRIC RESONATOR in the form of a disk and comes to rest below the vacuum interrupter VACUUM TUBE and provides the entire arrangement with additional stability.

The improvement produced, inter alfa, by the dielectric resonator HIGH-DC DIELECTRIC RESONATOR, is based in this case on the use of radio-frequency energy as actuator energy for actuating the switch of the vacuum interrupter VACUUM TUBE, because this is transmitted to the switch for this purpose, (that is to say the wave is guided to the switch).

In contrast to the use of a dielectric waveguide, it is therefore possible to change to lower frequencies in the MHz range and therefore achieve higher energy efficiency.

The mechanical actuator may be in the form of an electromagnet.

In the exemplary embodiment illustrated, the actuator is a bolt DIELECTRIC CRANK produced from dielectric material, the vacuum interrupter VACUUM TUBE is switched electrically, for example is illustrated, with the aid of a relay RELAY.

In this case, the bolt is advantageously guided in the dielectric resonator HIGH-DC DIELECTRIC RESONATOR having a recess such as a hole, for example, in the center, for this purpose in the exemplary embodiment.

FIG. 4 depicts another exemplary embodiment differing from the exemplary embodiment depicted in FIG. 3 only in that it has a metal bolt METALLIC CRANK.

The advantages discussed below and the parts of the exemplary embodiment that are disjoint with respect to the bolt therefore relate not only to this example but also apply to the example depicted in FIG. 3.

Another advantage of the exemplary embodiment shown is that the resonator simultaneously insulates, stabilizes and enables the transmission of the power needed for the switching operation. Furthermore, any possible heat produced may be dissipated via this resonator HIGH-DC DIELECTRIC RESONATOR.

It is also possible to see a signal generator MICROWAVE SIGNAL GENERATOR that uses a power amplifier MICROWAVE POWER AMPLIFIER to generate the required RF power signal (for example, in the microwave or MHz range) rectified at the other end of the dielectric waveguide HIGH-DC DIELECTRIC RESONATOR by a rectifier device MICROWAVE RECTIFIER and is supplied to the relay RELAY.

In this case, a plurality of rectifiers may be operated in a parallel manner as alternative developments for higher RF powers. The rectifier may include one or more diodes. The diodes may be Schottky diodes or other diodes or else modified transistors. The semiconductors may be based on a GaAs or GaN technology or another technology.

The rectifier may also be advantageously developed by being buffered or stabilized by corresponding circuitry measures. For example, the DC power may be buffered in a capacitance and may then be made available to the actuator, that is to say the relay RELAY here, for actuating the vacuum switch VACUUM TUBE.

The dielectric resonator HIGH-DC DIELECTRIC RESONATOR is a high-quality resonator (e.g., high dielectric constant “high-dc”), whereas a metal plate LOW-DC BASE has a low dielectric constant (“low-dc”).

The same applies to the holder LOW-DC SUSPENSION opposite the metal plate LOW-DC BASE. This is likewise produced from a metal having low permittivity.

The entire assembly may be cast, which may be an advantage over switching linkages. Further advantages of this may be the avoidance of sparkovers, climatic encapsulation or improved cooling.

One or more tubes may be operated in a parallel manner inside the assembly, which may result in economic advantages, for example. Parallel or serial operation is facilitated by the possibility of achieving a high degree of switching synchronicity using simple electromechanical measures. This switching synchronicity may be achieved by being able to superimpose a suitable trigger signal on the radio-frequency signal transmitting the energy.

The mechanical actuator or other parts on the interrupter or the entire arrangement may be equipped with sensors that measure relevant operating information. The information may be simultaneously transmitted back via the resonator HIGH-DC DIELECTRIC RESONATOR during the power transmission.

Other forms of energy conversion without rectifiers for actuating the switch are likewise conceivable. For example, operation during which the RF energy is used to heat a gas volume is conceivable. This gas volume expands on account of the heating and therefore drives a piston connected to the tube. This enables a slow switching operation. Instead of the gas, the use of water is also conceivable, which is heated by the RF energy, is evaporated and therefore drives a piston.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1.-10. (canceled)

11. An arrangement for switching an open contact gap, the arrangement comprising:
a switching device having a switching lever;
a radio-frequency source; and
a dielectric resonator in form of a disk, wherein the dielectric resonator is positioned on a side of the switching lever of the switching device such that the dielectric resonator stabilizes movement of the switching lever in a guiding manner,
wherein the switching device is connected to the radio-frequency source via the dielectric resonator for energy transmission,
wherein the switching device is configured to convert a DC-isolated energy transmission of radio-frequency energy into actuator energy.

12. The arrangement of claim 11, wherein the switching device is a vacuum interrupter.

13. The arrangement of claim 11, wherein the dielectric resonator is positioned on the side of the switching lever via bolts.

14. The arrangement of claim 11, wherein the dielectric resonator is a high-quality dielectric resonator on account of a high dielectric constant.

15. The arrangement of claim 11, wherein the switching lever is a metal or a dielectric material.

16. The arrangement of claim 11, wherein the switching device comprises at least one rectifier arrangement configured to convert the transmitted energy into the actuator energy.

17. The arrangement of claim 16, wherein the at least one rectifier arrangement comprises at least two parallel rectifier arrangements.

18. The arrangement of claim 11, further comprising:
electrically operated switches are connected downstream of the energy transmission as actuators.

19. The arrangement of claim 18, wherein the electrically operated switches are relay switches.

20. The arrangement of claim 11, wherein the resonator comprises a solid dielectric aluminum oxide material or another dielectric material with a high dielectric constant (cr).

21. The arrangement of claim 20, wherein the another dielectric material is titanium dioxide, zirconium, or silicon carbide.

22. The arrangement of claim 11, wherein one or more of the switching device, the radio-frequency source, or the dielectric resonator comprise sensors.
